(19) United States
(12) Patent Application Publication
(10) Pub. No.: US 2006/0288165 A1
(43) Pub. Date: Dec. 21, 2006

(54) Serialization of media transfer communications

(75) Inventors: Oren Rosenbloom, Redmond, WA (US); Vladimir Sadovsky, Bellevue, WA (US); Blake D. Manders, Kirkland, WA (US); Joseph D. Ternasky, Mountain View, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/167,587

(22) Filed: Jun. 28, 2005

Related U.S. Application Data
(63) Continuation-in-part of application No. 11/154,633, filed on Jun. 17, 2005.

(51) Int. Cl. G06F 12/00

(52) U.S. Cl. 711/115

(57) ABSTRACT

A system and method for removable storage content transfer. A removable storage medium is passed between a terminal and a device, and a device file stored on the removable storage medium is used to communicate media content and other information between the terminal and the device. The device file may include “session information,” such as information that can be used to represent a network or direct connect session between the terminal and the device file. The session information may include, for example, media content and header information. The device file may allow the terminal to treat the removable storage medium as a locally connected device in some situations. For example, the terminal may create a device stack using device parameters stored on the removable storage medium, and use the device stack to communicate with the device via the removable storage medium.

### CROSS-REFERENCE TO RELATED APPLICATIONS

This application is a Continuation In Part of application Ser. No. 11/154,633, Entitled “Removable Storage Content Transfer,” filed Jun. 17, 2005 with Attorney Docket No. MFCP. 119137, which is incorporated by reference herein in its entirety.

### STATEMENT REGARDING FEDERALLY SPONSORED RESEARCH OR DEVELOPMENT

None.

### BACKGROUND

Many consumer electronic devices, such as cameras, personal music players, and the like, store files or other content capable of being played back. Increasingly, a personal computer is being used as primary storage for such content. Electronic devices are therefore being designed to interface with personal computers to exchange content.

For example, a digital camera may transfer photograph files to a personal computer hard drive. As another example, a personal music player may receive music files from a personal computer.

Storage cards, such as, for example, a Compact Flash (CF) memory card, Secure Digital (SD) memory card, a Memory Stick, or the like, may be used to transfer content between an electronic device and a personal computer. Such storage cards may include, for example, a removable memory device including flash memory. A device may write to a storage card, and the storage card may then be removed from the device and inserted into a personal computer, which may retrieve information from the storage card. Similarly, a personal computer may write to a storage card, and the storage card may then be removed from the personal computer and inserted into the device, which may retrieve information from the storage card. For example, a storage card may be used to transfer photographs from a camera to a personal computer, or to transfer music files from a personal computer to a personal music player.

In some cases, it may be advantageous for a personal computer to process the content before or after a transfer. For example, it may be advantageous to transcode information, that is, to converted coded information from one encoding format into another encoding format. As another example, a music file may be stored in the personal computer as a relatively large high-fidelity file. Prior to transferring the music file to a personal music player for playback, it may be advantageous to represent the music file as a smaller low-fidelity file As another example, metadata may be added to photographs received from a camera.

In many cases, content, such as, for example, copyrighted media content, may include protection features, such as by implementing Digital Rights Management (DRM) features. However, multiple technical mechanisms for content protection exist, and various devices may handle content protection mechanisms differently. Furthermore, DRM may specify restrictions on a particular content, a particular device, or both. For example, a subscription DRM service might allow a user unlimited playback of all content on a particular personal music player, such as allowing unlimited playback of all music for one month. As another example, a per-use DRM service might allow a user to play a particular content a particular number of times, such as allowing a user to play a movie once, or allowing a user to play a song three times. The multiplicity of technical mechanisms, the different types of restrictions, and the different methods of handling DRM used by different devices may each complicate the transfer or playback of DRM content.

### SUMMARY

A set of conventions and operations can be followed by both a device and a terminal to allow a removable storage medium to act as a network connection. With such conventions and operations in place, the terminal can configure the device and media objects can be transferred between the device and the terminal solely by the movement of the removable storage medium between the device and the terminal. These capabilities may be equivalent to the configuration and transfer capabilities that would be allowed by the network connection between the device and the terminal, allowing for the high latency incurred by the physical movement of the storage medium between the device and the terminal.

In various embodiments, a system and method for removable storage content transfer are provided. A removable storage medium is passed between a terminal and a device, and a device file stored on the removable storage medium is used to communicate media content and other information between the terminal and the device. The device file may include “session information,” such as information that can be used to represent a network session between the terminal and the device file. The session information may be made up of one or more segments, each segment containing one or more requests and/or responses. Furthermore, the session information may include, for example, media content and header information along with any other communication stream that may otherwise occur if two or more devices were directly connected via wired or wireless communication protocol. The device file may allow the terminal to treat the removable storage medium as a locally connected device in some situations. For example, the terminal may create a device stack based upon the device file using device parameters stored on the removable storage medium, and use the device stack to communicate with the device via the removable storage medium.

One particular application is the creation and transfer of metadata. In order to provide a responsive and useful user interface, a device may represent its content using human-readable data. For example, a user interface for playback of audio files should present the user with metadata such as the title, artist, album, duration, and the like. While a terminal may obtain such metadata from an outside source, such as an online source, or may or generate such metadata, for example, by interpreting file headers; many devices lack the resources to obtain or generate useful metadata. One implementation therefore provides a method for a terminal to obtain or generate such metadata, and for the metadata to be transferred to a device. Other implementations allow a terminal to generate other types of metadata, such as encoding parameters (for example, the bitrate of a media file), abstracted content (for example, Personal Information Manager data), and the like.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawings figures, wherein:

FIG. 1 is block diagram illustrating a computerized environment in which embodiments of the invention may be implemented;

FIG. 2 is a block diagram illustrating an overview of a system in accordance with an embodiment of the present invention;

FIG. 3 is a block diagram illustrating an overview of a storage medium in accordance with an embodiment of the present invention;

FIG. 4 is a flow chart illustrating a method for communicating with a device, in accordance with an embodiment of the present invention;

FIG. 5 is a flow chart illustrating a method for communicating with a terminal, in accordance with an embodiment of the present invention; and

FIG. 6 is a block diagram illustrating an overview of a system in accordance with an embodiment of the present invention.

### DETAILED DESCRIPTION

In one implementation, the invention relates to a system and method for removable storage content transfer. A removable storage medium, such as a memory stick or the like, may be used to transfer information between a device and a terminal, such as a personal computer.

A synchronization, or “sync,” operation may be used to transfer information between two or more devices with disparate information. The intention of a sync operation may be that all of the devices will eventually hold a common subset of information. In one implementation, communication may follow a sequence of information exchanges, which may make up a sync operation. A typical sequence of information exchanges may include the following:
1) Investigate the device
2) Investigate the device contents
3) Delete content from the device
4) Add content to the device

This sequence is not necessarily interactive with the device, but may be interactive with a storage medium used by the device. Thus, synchronixation can be performed by passing a storage medium back and forth between a device and a terminal.

The first and second steps transfer information from the device to a terminal. In one implementation, a device may write information to a storage medium in a defined file format, and a terminal may read the information from the storage medium. Thus, the storage medium may provide all the information an application on the terminal would require to perform functions such as device-specific media encoding, metadata-based views of device/storage content, and the like.

The third and fourth steps transfer information from the terminal to the device. The terminal may, for example, choose to add to, deleted from, or re-arrange the contents of the device. Rather than performing this interactively, the terminal may directly modify the content on the storage medium, and the actions taken on that content may be logged in a defined file format so the device can later process it as though it were communicated in an active session.

In one implementation, synchronization can be performed in one “round-trip” of a storage medium. A round-trip may be completed when the removable storage medium has been accessed by each device in the group of devices at least once. To synchronize a particular device, a round-trip may consist of that device accessing the removable storage medium at least once before all the other devices in the group of devices, and again at least once after all the other devices in the group of devices. In one implementation, to perform a sync operation between a device and a terminal, a round-trip may consist of the device accessing the storage medium, the terminal accessing the storage medium, and the device again accessing the storage medium.

In one implementation, a sync operation including error processing may be accomplished in two round-trips of the storage medium. In the first round-trip, the storage medium may be transferred from the device to the terminal, which may place commands on the storage medium, and the storage medium may then be transferred back to the device. If the device is unable to process the commands on the storage medium, the device may place an error message on the storage medium. During the second round-trip, the storage medium may be transferred to the terminal, and the error message may be processed by the terminal. In this implementation, a defined container file format may be provided for errors. The second round trip can be performed the next time the user wishes to transfer information between the device and the terminal. Thus, the second round-trip can be used for media transfer or sync operations concurrently with the communication of error messages.

By separating the steps of device synchronization into two standard processes, the interactive process of device synchronization can be performed in a single exchange of a storage medium. Furthermore, device information may be communicated in a flat file on the storage medium. This device information may allow the terminal to communicate with the storage medium as though it were the device. Thus, the synchronizing application on the terminal may not recognize the storage medium as simple storage, but may consider it to be the device itself.

In one implementation, the data that is transferred between the device and the terminal may be arranged into a standard file format. The standard file format may be the same data that would be sent to and from the device in an actual interactive session, serialized to a flat file (possibly with additional formatting information). This configuration allows devices to be built using only one set of processing logic, independent of whether the device contents are transferred by an interactive direct session or by storage medium exchange.

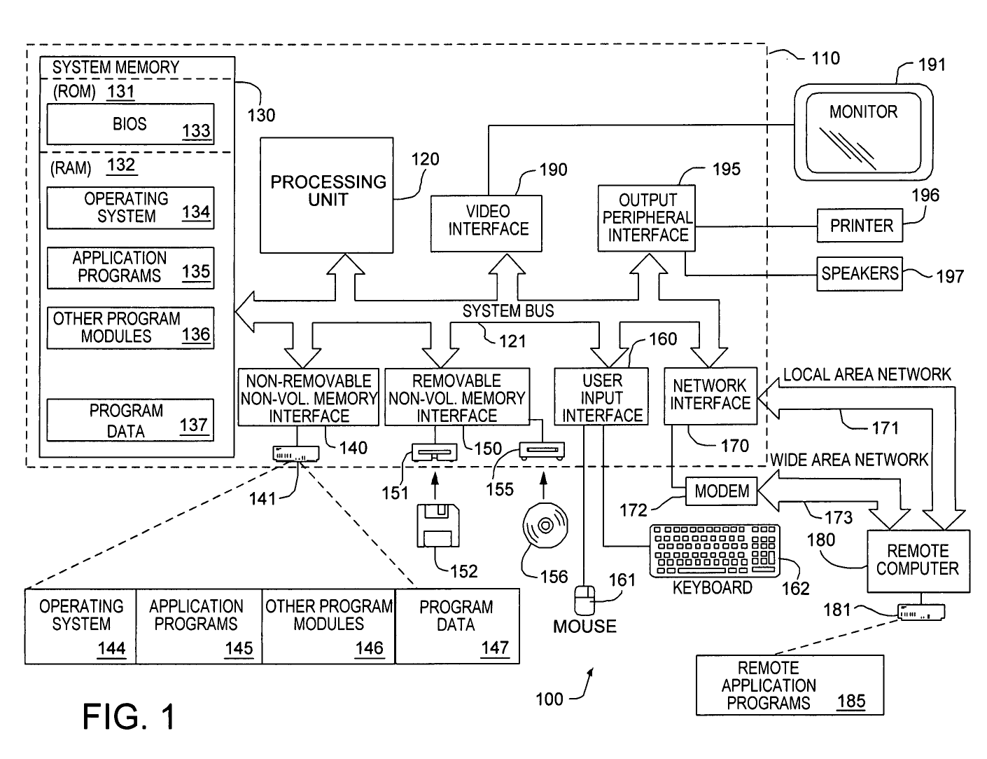

FIG. 1 illustrates an example of a suitable computing system environment 100 on which the system for serialization of media transfer may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

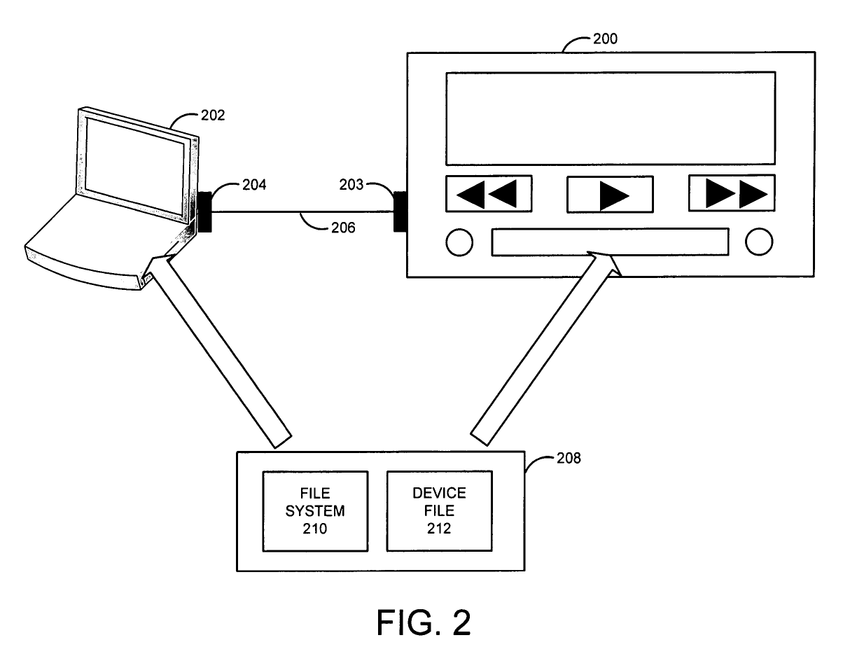

FIG. 2 is a block diagram illustrating an overview of a system in accordance with an embodiment of the present invention. As shown in FIG. 2, a device 200, such as a consumer electronic device, may receive content from or transfer content to a terminal 202, such as a personal computer. Each of the device 200 and the terminal 202 may be equipped with one or more storage readers and/or writers. The device 200 may be, for example, an automotive built-in media system, a portable digital stereo system, a home entertainment system with built-in storage, a camera, a portable gaming device, a mobile telephone, or any other electronic system. In some implementations, a plurality of devices 200 may receive content from or transfer content to the terminal 202.

The device 200 and the terminal 202 both may implement a configuration and transfer protocol that allows for configuration of the device 200 and the exchange of information between the device 200 and the terminal 202 when a network connection 204 is established between the device and the PC. For example, both the device 200 and the terminal 202 may have Universal Serial Bus (USB) connectors 203, 204 so that the device 200 can be connected to the terminal 202 via a direct USB cable 206 or some combination of USB cables and USB hubs. In some implementations, Media Transfer Protocol (MTP) is used as the configuration and transfer protocol, and both the device 200 and the terminal 202 may implement MTP allow for configuration of the device 200 and the transfer of media objects between the device 200 and the terminal 202. When the device 200 and the terminal 202 are connected via the USB cable 206, information, such as MTP information, will be carried over the USB cable 206 such that configuration and transfer operations can be performed. Those skilled in the art will appreciate that other configuration and transfer protocols could be used, and that various transport protocols could be used. For example, MTP or another configuration and transfer protocol could be used in conjunction with Transmission Control Protocol/Internet Protocol (TCP/IP). As another example, Picture Transfer Protocol (PTP) could be carried over the USB cable 206 or used in conjunction with another transport protocol.

When a network connection is established between the device 200 and the terminal 202, via the USB cable 206 or some other connection, discrete packets of information may be sent from the device 200 to the terminal 202, or from the terminal 202 to the device 200. The time it takes to perform such a transfer may depend on the latency of the network connection, and how reliable such transmission is may depend on the reliability of the network carrying the connection. Both the configuration and transfer protocol and the transport protocol may include mechanisms to make the best use of the network connection (reduce the latency) while reducing transmission errors (improving the reliability).

The communication between the device 200 and the terminal 202 over the USB cable 206 or other network connection may include one or more sessions. Each session is, for example, a lasting communication involving the exchange of many packets.

The configuration and transfer protocol being used, such as MTP, may define one or more transfer protocol entities, which are software modules useful for configuration and transfer; such as operations, result codes, object formats, data types, data sets, data file references, and the like. The configuration and transfer protocol, such as MTP, may further define how these transfer protocol entities may be used. When configuration or transfer is performed via a USB cable 206 or other network connection, one or more of these transfer protocol entities may be sent within discrete packets as part of a session.

The device 200 and the terminal 202 may share a storage medium 208. In one implementation, the storage medium 208 is a removable read/write storage medium such as a memory card or magnetic disk. When the storage medium 208 is inserted into the device 200 or otherwise placed in communication with the device 200, software running on the device 200 may access the contents of the storage medium 208. Likewise, when the storage medium 208 is inserted into the terminal 202 or otherwise placed in communication with the terminal 202, software running on the terminal 202 may access the contents of the storage medium 208. The storage medium 208 may be formatted with a file system 210 that allows individual files to be created, read, written, or deleted. Software running on both the device 200 and the terminal 202 may implement support for the file system 210, providing access to files stored on the storage medium 208 to both the device 200 and the terminal 202.

The storage medium 208 may be routinely moved back and forth between the device 200 and the terminal 202. In this case, the storage medium 208 may be formatted in such a way that software running on both the device 200 and the terminal 202 can access and modify information in files carried on the storage medium 208. When the device 200 and the terminal 202 communicate by modifying files stored on the storage medium 208, the storage medium 208 can be treated as a network connection. This configuration may allow the device 200 and the terminal 202 to communicate without the USB cable 206.

As discussed above, when a network connection is used for configuration or transfer, a session is established, including one or more discrete packets sent over a USB cable 206 or other network connection. The packets may included transfer protocol entities; such as operations, result codes, object formats, data types, data sets, data file references and the like; that are defined by MTP or another configuration and transfer protocol.

Similarly, when configuration or transfer is performed via a storage medium 208 rather than a network connection, these transfer protocol entities may be used in a like fashion, to carry out device configurations or transfers. Instead of sending these transfer protocol entities within discrete packets over USB cable 206 or other network connection, the transfer protocol entities may be recorded within a device file 212 on the storage medium 208. The information stored in the device file 212 may be recorded, for example, as a byte stream. The device file 212 may include all the information that would be transmitted during session, and the device file 212 may therefore be said to “represent” a session. In one implementation, all the transfer protocol entities, header information, and other information that would be communicated between the device 200 and the terminal 202 during a session are recorded into the device file 212.

As the storage medium 208 is passed between the device 200 and the terminal 202, information is passed between the device 200 and the terminal 202, allowing for bi-directional communication. The device file 212 may record the transfer protocol entities sent in either direction, including packet “headers” that describe where the packet originated (for example, from the device 200 or the PC 202) and the packet's destination. Likewise, the device file 212 may include other packet header information, such as sequence numbers, session identifiers, transaction identifiers, etc. that may be used to represent a complete session. A device file 212 can be viewed as a “serialized” session between one device 200 and one terminal 202, in the sense that the information in a device file 212 is sufficient to construct a session that would have the intended effects on both the device 200 and the terminal 202.

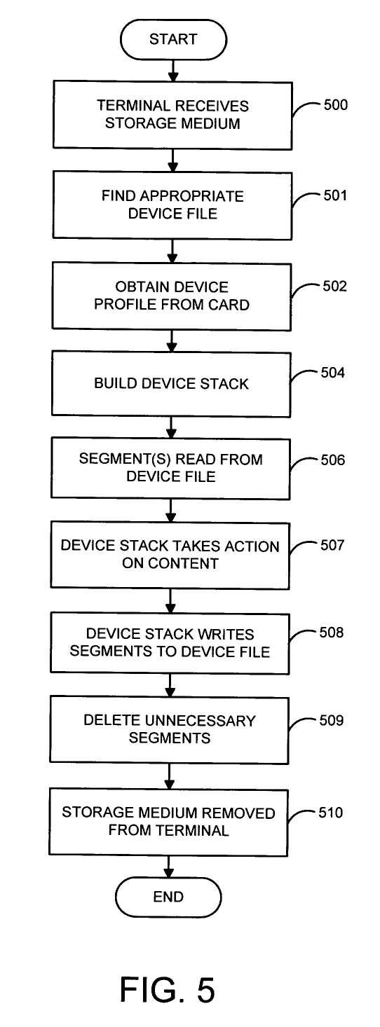

When the storage medium 208 includes a device file 212 representing a session, the storage medium 208 may be treated in some instances as a locally connected device. For example, programs, protocols, and data structures that are used to transfer information to and from locally connected devices may be utilized. As a particular example, the Windows operating system may use a device stack to transfer information to and from locally connected devices. The device file 212 representing a session allows the operating system to communicate with the device using a device stack. Details of the device stack will be discussed further with reference to FIG. 5.

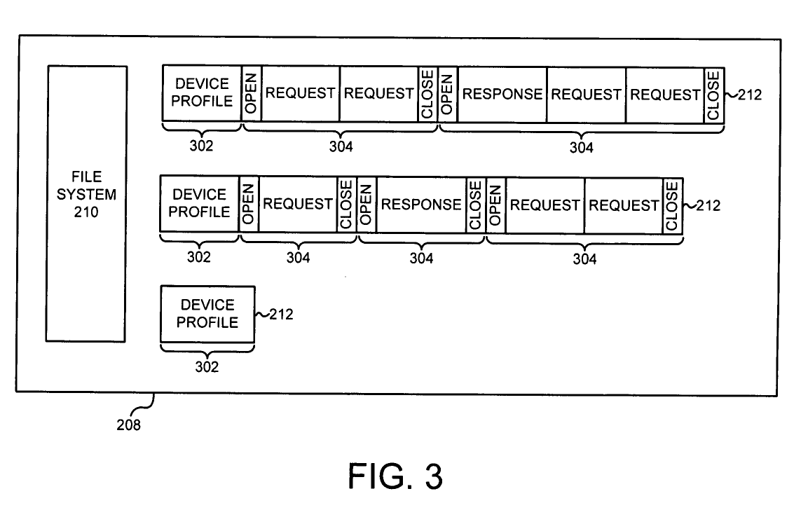

FIG. 3 is a block diagram illustrating an overview of a storage medium in accordance with an embodiment of the present invention. As shown in FIG. 3, the storage medium may include a file system 210, which may provide access to files stored on the storage medium 208. The storage medium 208 may further include one or more device files 212. The storage medium 208 may be used, for example, for communication between two or more devices and/or terminals (not shown in FIG. 3) by means of passing the storage medium 208 back and forth between the devices and/or terminals.

Each device file 212 may represent a communication between one terminal and one device. As an example, a plurality of devices may use the storage medium 208 to communicate with a central terminal. In this case, each device may create a separate device file 212 used for communication with the central terminal.

Each of the device files 212 may contain a device profile 302. Each device profile 302 may identify the device using the device file for communication. In one implementation, each device profile 302 contains enough information for each device to determine which device file 302 corresponds to that device. For example, each device profile 302 may contain a unique device identifier.

In one implementation, a device file directory is used to simplify access to the device files 212 stored on the storage medium 208. In this implementation, the device profile information 302 may be stored in the device file directory. A device searching for the appropriate device file 212 may search the device file directory for the appropriate profile information 302, and then follow a pointer in the device file directory, or otherwise use the device file directory, to access the corresponding device file 212.

In one implementation, each device using the storage medium 208 writes a device profile 302 into a device file 212 and/or into a device file directory at the time the device file 212 is created. The device profile 302 may be defined by the configuration and transfer protocol as a dataset that is used to characterize the device. For example, if MTP is the configuration and transfer protocol, each device may create a device file 212 and write a “DeviceInfo” dataset into a device profile 302 in the device file 212 and/or the device file directory. At a later time, when the device is searching for the appropriate device file 212 on the storage medium 208, the DeviceInfo dataset in the device profile 302 may allow the device to determine exactly which device file 212, if any, corresponds to that device.

Each device file 212 may contain zero or more segments 304. Each segment 304 may be session information that is written by one party to the communication, either a device or a terminal, and read by the other party. For each segment 304, the writing party may be referred to as the Initiator and the other party may be referred to as the Responder. The Initiator and Responder may communicate using any appropriate configuration and transfer protocol. In each segment 304, the Initiator may include zero or more responses, where each response corresponds to a request by the other party in a previous segment 304. The Initiator may also include zero or more requests in a segment 304, where each request is intended to trigger a response from the Responder in a future segment 304. The requests and responses may appear in any order within the segment 304. In some implementations, this model of segments 304, requests, and responses may not correspond directly to the model defined by the configuration and transfer protocol. In that case, the rules of the configuration and transfer protocol may be relaxed to allow the model of segments, requests, and responses.

In one implementation, each segment 304 may be bracketed, for example, by information in the device file 212 that delimits the extent of each segment 304. For example, where MTP is the configuration and transfer protocol, each segment 304 may be bracketed by “OpenSession” and “CloseSession” requests. In one implementation, no responses to these OpenSession and CloseSession requests are included within the segment 304, although responses to other requests may appear in the segment 304.

The following example illustrates how a device file 212 may be used for communication between a device and a terminal. In this example, MTP is the configuration and transfer protocol. A terminal may write a segment 304 to a device file 212 with a “SetDevicePropValue” request, including the new property value as part of the request. Later, when the storage medium 208 is inserted into the device to which this request was addressed, the device may respond to this request by appending a new segment 304 to the device file 212. This new segment may include a response to the “SetDevicePropValue” request, including, for example, a response code indicating success or failure in modifying the property value.

A request for information and the subsequent response addressing the request may be referred to as “related.” In one implementation, related requests and responses within a device file contain common information that may be used to determine their relationship. For example, where MTP is the configuration and transfer protocol, a related request and response may share a common “SessionID” and “TransactionID.” Different requests or responses in a single segment 304 of the device file 212 may use different SessionID and/or TransactionID values, since these items may not be related to each other. This may be an example of a mismatch between the MTP concept of sessions and transactions and the concepts of device files and segments used in the device files 212. However, in one implementation, the rules of MTP may be relaxed, for example, to allow for a segment that includes requests and responses with different SessionIDs and/or TransactionIDs. In other implementations, other configuration and transfer protocols may be used, and the rules of the configuration and transfer protocols may be relaxed to allow for serialized communication using a removable storage medium.

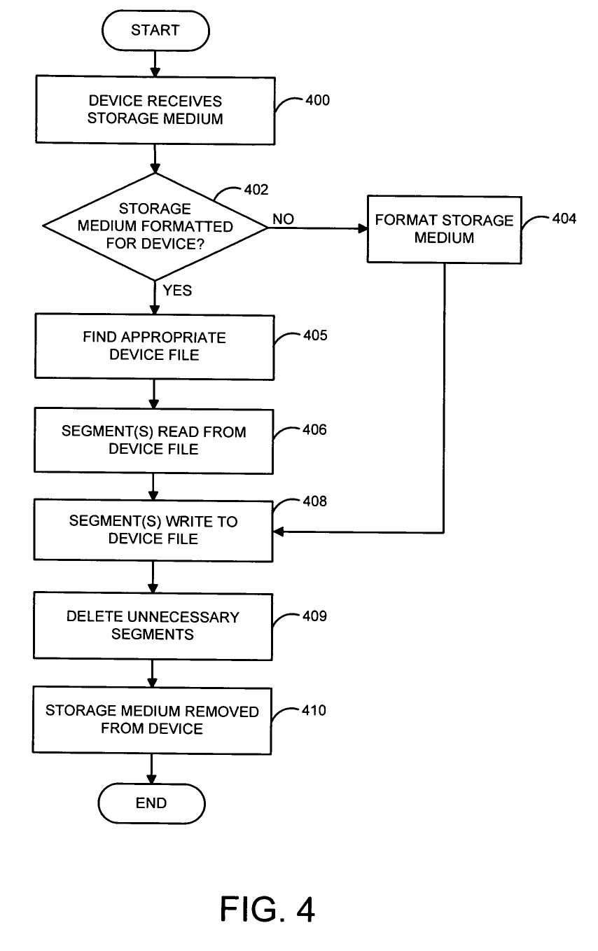

In one implementation, the device files 212 may grow longer as additional segments 304 are appended to the device files 212. A device or terminal may eliminate segments 304 from a device file 212 to reclaim the storage used by the device file 212. Eliminating unnecessary segments from a device file 212 will be discussed further below with reference to FIGS. 4-5.

An example explaining the system from end to end is as follows: A storage card may be used as a means to connect two or more devices that would otherwise never be directly connected. These devices understand a common communication protocol, such as MTP as an example. A set of protocol operations can be serialized, or saved to a file that is stored on the removable storage medium, such as a compact flash memory card. One such example of a session is a mechanism for explaining the types of files that a device may support. For example, a particular device that only supports the transfer of photos may record to its device file on its removable storage that only photos are understood by the device. When this removable storage is directly inserted into a terminal, the terminal would parse the device file and then instantiate a device stack with an extra virtual layer bound to the device file that emulates the actual device. As such, the terminal believes it is directly communicating with the device and will determine that only photos can be transferred to/from the device. The terminal may then choose, for example, to transfer a photo to that virtual device. This operation will result in another device file on the removable storage that indicates that a new object is being created on the device, and a reference to the actual photo file that was saved to the removable storage. When this removable storage is then inserted back into the device, the device will read the new device file that was created by the terminal and conclude that a new photo file was added and the device file explains the attributes of this new photo file. Examples of some attributes, or metadata could include, the size of the file, the name of the file, the date/time the file was transferred, etc. This example is merely illustrative and those skilled in the art will appreciate that many other implementations and applications are possible.

Other applications for serialized communication are contemplated. For example, serialized communication may be used to perform content synchronization between a device and a terminal, or to perform content synchronization between two or more devices, optionally using the terminal as a common content depot. As another example, serialized communication may further be used for propagation of user preferences, settings and configuration from a terminal to one or more devices, or for collection of recent user settings from one or more devices into a terminal. Furthermore, serialized communication may be used for transfer of DRM keys from a service to the device by way of the terminal, or for transmitting requests for updated DRM keys from one or more devices to the service by way of the terminal. Further applications may include transferring content from a service to the device by way of a terminal, or transmitting requests for content from the device to the service by way of the terminal. Still further applications may include synchronization of device clocks, time zones, or locations from the terminal to one or more devices. Still further applications may include discovery of new devices on the terminal, exposing additional device-specific user interfaces or features on the terminal when new devices are discovered, or exposing additional user interfaces or features on the terminal when a new combination of devices is discovered. Many other applications will be apparent to those skilled in the art.

FIG. 4 is a flowchart illustrating a method for communicating with a terminal. As shown in FIG. 4, the method may begin in step 400, wherein a device may receive a storage medium. For example, the storage medium may be inserted into a slot or disk drive, or otherwise placed in communication with the device.

The method may continue in step 402, wherein it is determined whether the storage medium has been formatted for the device. In one implementation, the device determines whether or not the storage medium has been formatted for the device, for example, by detecting the presence of device-specific information on the storage medium. For example, the device may detect the presence of a device profile, a device file, or other information on the storage medium.

If the storage medium has not been formatted for the device, in step 404, the device may format the storage medium. Formatting the storage medium may include, for example, creating and/or storing a device file and/or device profile on the storage medium. The method may continue in step 408.

In one implementation, the device file and/or the device profile may be written into a secured portion of the storage medium, for example, with the assistance of a storage microcontroller. This implementation may protect device-specific information against accidental erasure.

If it is determined in step 402 that the storage medium has been formatted for the device, the method may continue in step 405, wherein the appropriate device file is found on the storage medium. The device may find the appropriate device file, for example, by searching for a device file that includes a device profile that corresponds to that device. In one implementation, a device file directory may be used to find the appropriate device file.

In step 406, one or more segments may be read from the device file. In one implementation, the segment(s) read may include, for example, one or more requests and/or responses. In step 408, one or more segments may be written to the storage medium. In one implementation, the segment(s) written may include, for example, one or more requests and/or responses. Writing segment(s) includes, for example, storing these requests and/or responses into the device file as a byte stream. In one implementation, the requests and/or responses include one or more media transfer entities. The requests and responses read from or written to the storage medium may include media content or an indication of content transfer, such as a request for content, a result code indicating successful content transfer, header information, or other information.

In step 409, the device may delete unnecessary segments from the device file. In one implementation, segments may be preserved within the device file while any requests in the segment do not have related responses within the same device file. Furthermore, in one implementation, a segment should only be removed from the device file when the requests made by that segment have been acknowledged by the Initiator. In one implementation, this acknowledgement may not be formally given, so the segment may typically removed by the Initiator. In this implementation, the device removes segments for which it was the Initiator. In another implementation, however, the Responder may remove a segment, for example, if the Initiator has made additional requests after receiving responses to all requests in the segment. In yet another implementation, the device may simply delete the entire existing device file, create a new device file, and initialize it by creating a device profile.

In step 410, the storage medium may be removed from the device. For example, the storage medium may be removed from a card slot or disk drive, or otherwise withdrawn from communication with the device.

FIG. 5 is a flowchart illustrating a method for communicating with a device. As shown in FIG. 5, the method may begin in step 500, wherein a terminal may receive a storage medium. For example, the storage medium may be inserted into a slot or disk drive, or otherwise placed in communication with the terminal.

In step 501, wherein the terminal may find the appropriate device file on the storage medium. The terminal may find the appropriate device file, for example, by searching for a device file that includes a device profile that corresponds to a particular device with which the terminal wishes to communicate. In one implementation, a user may be contacted with a list of potential devices and asked to choose the device with which to communicate. In another implementation, user preferences that have been input in advance are used to determine the device with which to communicate. In yet another implementation, a device file directory may be used to find the appropriate device file.

The method may continue in step 502, wherein a terminal may obtain a device profile from the device file or elsewhere on the storage medium. In step 504, a device stack may be built. The device stack may be, for example, software that is configured to facilitate communication by simulating a connection to the device. The device stack may be built, for example, by the operating system based on the device profile obtained from the storage medium. The device stack may include, for example, a virtual layer configured to simulate the operation of the device and a driver configured to communicate between the storage medium the operating system or a content application.

In step 506, one or more segment(s) may be read from the device file. Reading segment(s) 506 may include, for example, In step 406, one or more segments may be read from the device file. In one implementation, the segment(s) read may include, for example, one or more requests and/or responses. In one implementation, the requests and/or responses include one or more media transfer entities. The requests and responses read from the storage medium may include media content or an indication of content transfer, such as a request for content, a result code indicating successful content transfer, header information, or other information.

In step 507, action may be taken on the content. In an implementation of the invention, action taken on the content is performed via the terminal. In this implementation, the terminal is therefore responsible, for example, for actions such as compressing the content, adding metadata to the content, performing DRM functions associated with the content, or performing other actions to facilitate communication between the device and the terminal.

Taking action on the content 507 may be performed, for example, in communication with a DRM engine or other protected content engine, an operating system, and/or a content application. If content is received in the session information in step 406, taking action on the content may include processing the received content and storing it in the terminal. For example, metadata may be added or DRM functions may be performed prior to storing received content in the terminal. If a request for content is received in step 506, taking action on the content may include processing content to be transmitted to the device. For example, content may be retrieved from local storage on the terminal, and the content may be compressed or DRM functions may be performed in preparation for transmitting the content to the device.

In one implementation, a plurality of DRM engines may be provided for handling various DRM schemes. In this case, an appropriate DRM engine may be selected for performing action on content. An appropriate DRM engine may be selected, for example, for communication with a particular device. In this case, the DRM engine may be selected based on the device profile or the device file. Furthermore, an appropriate DRM engine may be selected based on user preferences or terminal parameters. In this case, preferences or parameters stored on the terminal may be used to select the DRM engine. The DRM engine is an example of a protected content engine used in embodiments of the invention. Those skilled in the art will appreciate that other types of protected content engines used for protection and/or playback of protected content may be used.

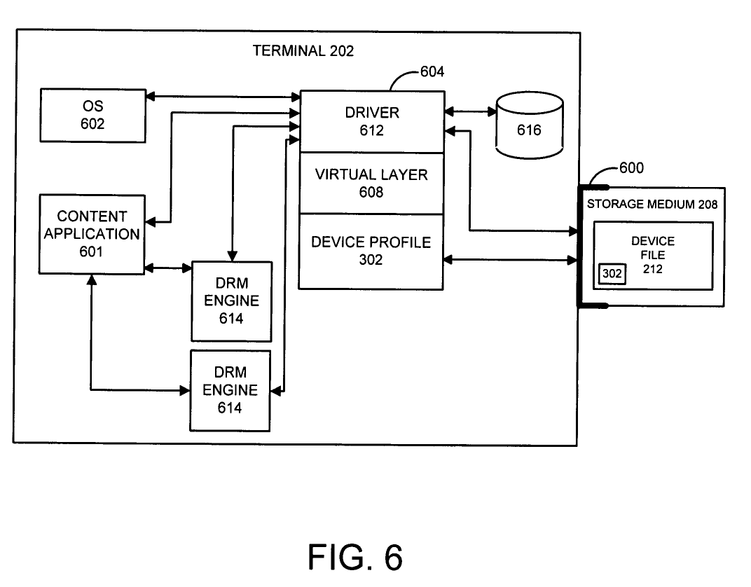

In step 508, one or more segments may be written to the storage medium. In one implementation, the segment(s) written may include, for example, one or more requests and/or responses. Writing segment(s) includes, for example, storing these requests and/or responses into the device file as a byte stream. In one implementation, the requests and/or responses include one or more media transfer entities. The requests and responses read from or written to the storage medium may include media content or an indication of content transfer, such as a request for content, a result code indicating successful content transfer, header information, or other information. Taking action on content 507 and writing segments to the device file 508 will be discussed further with reference to FIG. 6.

In step 509, the terminal may delete unnecessary segments from the device file. In one implementation, segments may be preserved within the device file while any requests in the segment do not have related responses within the same device file. Furthermore, in one implementation, a segment should only be removed from the device file when the requests made by that segment have been acknowledged by the Initiator. In one implementation, this acknowledgement may not be formally given, so the segment may typically removed by the Initiator. In this implementation, the terminal removes segments for which it was the Initiator. In another implementation, however, the Responder may remove a segment, for example, if the Initiator has made additional requests after receiving responses to all requests in the segment.

In step 510, the storage medium may be removed from the terminal. For example, the storage medium may be removed from a card or disk drive, or otherwise withdrawn from communication with the terminal.

FIG. 6 is a block diagram illustrating an overview of a system in accordance with an embodiment of the present invention. As shown in FIG. 6, a terminal 202 may be configured to receive a storage medium 208, such as a memory card or magnetic disk, via an input 600, such as a card slot, disk drive, or the like. The storage medium 208 may be used, for example, to communicate with a device (not shown in FIG. 6) by means of passing the storage medium 208 back and forth between the terminal 202 and the device.

The terminal 202 may include a content application 601 that communicates with the device via the storage medium 208. For example, in one implementation, the content application 601 may be a digital media player configured to communicate with a personal music player device. In this case, the content application 601 is configured to transmit media files to, or receive media files from, the personal music player. In another implementation, the content application 601 may be an application for storing and manipulating photographs. In this case, the content application 601 may be configured to receive photographs from, or transmit photographs to, a camera device. Other implementations including other content applications 601, other content types, and other devices are possible.

The terminal 202 also includes, for example, an operating system 602. The operating system 602 may be configured to communicate with the device via the storage medium 208.

When the storage medium 208 is inserted into the input 600, a device stack 604 may be created. In one implementation, the device stack 604 is created by the operating system 602. The device stack 604 is, for example, software that is configured to facilitate communication by simulating a connection to the device.

In order to create the device stack 604, a device profile 302 may be read from a device file 212 on the storage medium 208 and stored in the terminal 202. The device profile 302 may be or include, for example, parameters specifying properties or attributes of the device, or otherwise describing the device. The device profile 302 may include such information as the type of device, the type of content accepted by the device, the compression schemes used by the device, available memory on the device, Digital Rights Management information for the device, and the like. The device profile 302 may be written to the storage medium 208, for example, by the device during formatting.

In order to create the device stack 604, a virtual layer 608 may be created, for example, based on the device profile. In one implementation, the virtual layer 608 simulates the operation of the device. The combination of the device file 212 and the virtual layer 608 may be said to comprise a “virtual device.” The operation of the virtual device may be such that, from the perspective of the terminal 202, the device appears to actually be connected to the terminal 202.

The device stack may also contain a driver 612. The driver 612 is, for example, a software module configured to communicate between the storage medium 208 and the content application 601 or the operating system 602. In one implementation, the driver 612 receives a device file 212 from the storage medium 208 or otherwise accesses the device file 212 on the storage medium 208. The driver 612 may also receive information and/or instructions from the content application 601 and/or the operating system 602. Based on the information in the device file 212, the information received from the content application 601, and/or the information received from the operating system 602, the driver 212 determines whether content should be transmitted from the device file 212 to the terminal 202, and whether content should be transmitted from the terminal 202 to the device file 212.

If the driver 612 determines that content should be written from the device file 212 to the terminal 202, the driver 612 retrieves the content from the device file 212. The driver 612 then determines whether any action should be taken on the content. The driver 612 determines whether action should be taken on the content, for example, by examining the virtual layer 608, the content application 601, and/or the operating system 602. Examples of action taken on content include, for example, compressing the content, adding metadata to the content, performing DRM functions associated with the content, or the like. If action should be taken on the content, the driver 612 performs such action, for example, by examining the virtual layer 608. In performing action on the content, the driver 612 may communicate with one or more DRM engines 614. After action is taken on the content, the modified content may be stored, for example, to a database 616. One or more transfer protocol entities indicating the operations that occurred, such as transfer protocol entities indicating that the content was received, modified, and/or stored may be written to the device file 212.

If the driver 612 determines that content should be written from the terminal 202 to the device file 212, the driver 612 retrieves the content, for example, from the database 616, the content application 601, or another location within the terminal 202. The driver 612 then determines whether any action should be taken on the content. The driver 612 determines whether action should be taken on the content, for example, by examining the virtual layer 608, the content application 601, and/or the operating system 602. Examples of action taken on content include, for example, compressing the content, adding metadata to the content, performing DRM functions associated with the content, or the like. If action should be taken on the content, the driver 612 performs such action, for example, by examining the virtual layer 608. In performing action on the content, the driver 612 may communicate with one or more DRM engines 614. After action is taken on the content, the modified content may be written, for example, to the device file 212. The modified content is stored, for example, as a bit stream in the device file 212. The modified content may be stored, for example, in conjunction with header data, transfer protocol entities, or other data.

In one implementation, the driver 612 may communicate with a plurality of DRM engines 614. In this case, the driver 612 and/or the virtual layer 608 may select an appropriate DRM engine 614 for performing action on content. An appropriate DRM engine 614 may be selected for communication with a particular device. In this case, the DRM engine may be selected based on the device profile, the device file 212 or the virtual layer 608. Furthermore, an appropriate DRM engine 614 may be selected based on user preferences or terminal parameters. In this case, preferences or parameters stored on the terminal 202 may be used to select the DRM engine 614 for performing action on content.

Because content may be modified on the terminal 202, the content stored in the device file 212 may be matched to the stream parameters, DRM model, and other expectations of the device. This may result in a smooth user experience that allows playback or other content consumption on the device with little or no input required from a user.

As target devices are frequently constrained, the large quantity of media content on the storage card may be organized to allow for improved device operation. To achieve this, an accelerator can be used in conjunction with the invention. For example, an accelerator may write an accelerator file to the storage medium, for example, as media content storage is being completed. The accelerator file may provide content metadata that may be accessed, for example, by a user interface for the device. An accelerator scheme used in conjunction with the present invention may be, for example, independent of the block file system which is used to format the card.

In some implementations, such as in the case of a device that is not capable of recording media content, an accelerator file such as, for example, a device-optimized metadata database, may be used. In various implementations, other accelerators may be used.

Implementations provide a coherent user experience by providing the terminal an accurate snapshot of the device parameters at the time when it runs the content. Implementations provide a standard scheme of encoding the device parameters, which allows the terminal to enable optimal device operation when transfer is done via a storage medium. The terminal can therefore create an accelerator file for use by the device, as well as taking action on media content to prepare the media content for the device.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

In particular, while the invention has been described in terms of a storage medium used for communication between a central terminal and one or more devices, in embodiments of the invention, a plurality of terminals could use the storage medium to communicate with each other and/or with external devices. In this case, terminal profiles identifying a terminal involved in a communication session could be stored instead of, or in addition to, the device profiles 302. Furthermore, in embodiments of the invention, a plurality of devices could use the storage medium to communicate with each other. In this case, two or more device profiles 302 could be included in, or associated with, each device file 212.

Furthermore, while various examples have described MTP as the configuration and transfer protocol used for serialized communication, those skilled in the art will recognize that other configuration and transfer protocols may be used. For example, Object Exchange (OBEX), Picture Transfer Protocol (PTP), Infrared Mobile Communications (IrMC), Web-based Distributed Authoring and Versioning (WebDAV), File Transfer Protocol (FTP), Hyper Text Transfer Protocol (HTTP), or any other appropriate protocol may be used for communication.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. One or more computer-readable media storing instructions thereon, the instructions being executable to cause a computer to perform a method comprising:
obtaining at least a first segment from a device file stored on a removable storage medium, the device file describing a session between a terminal and a device, and the first segment comprising at least one selected from the group consisting of a request and a response; and
transmitting at least a second segment to be stored in the device file on the removable storage medium, the second segment comprising at least one selected from the group consisting of a request and a response.

2. The computer-readable media of claim 1, further comprising:
selecting the device file based on a device profile stored on the removable storage medium.

3. The computer-readable media of claim 1, further comprising:
deleting at least a third segment from the device file.

4. The computer-readable media of claim 1, wherein the terminal and the device implement Media Transfer Protocol.

5. The computer-readable media of claim 1, wherein each request or response in the device file comprises:
an identifier used to find a related request or response.

6. The computer-readable media of claim 1, wherein the device file comprises media content.

7. The computer-readable media of claim 1, wherein the device file comprises at least one transfer protocol entity.

8. The computer-readable media of claim 1, wherein the storage medium contains a plurality of device files, each device file describing a session between a terminal and a device.

9. The computer-readable media of claim 1, wherein the device file is stored in a secure portion of the storage medium.

10. One or more computer-readable media storing instructions thereon, the instructions being executable to cause a computer to perform a method comprising:
creating a device file on a removable storage medium, the device file describing a session between a terminal and a device; and
transmitting a device profile to be stored on the storage medium, the device profile identifying the device.

11. The computer-readable media of claim 10, further comprising transmitting at least a first segment to be stored in the device file on the removable storage medium, the first segment comprising at least one selected from the group consisting of a request and a response.

12. The computer-readable media of claim 10, wherein the terminal and the device implement Media Transfer Protocol.

13. The computer-readable media of claim 10, wherein the session information includes at least one transfer protocol entity.

14. The computer-readable media of claim 10, wherein the device file is stored in a secure portion of the storage medium.

15. One or more computer-readable media storing instructions thereon, the instructions being executable to cause a computer to perform a method comprising:
obtaining a device profile from a removable storage medium, the device profile specifying at least one property of an external device; and
creating a virtual device based on the device profile, the virtual device emulating the behavior of the external device; and
establishing communication between a driver and the virtual device.

16. The computer-readable media of claim 15, wherein the method further comprises:
placing the driver in communication with at least one protected content engine.

17. The computer-readable media of claim 15, wherein the method further comprises:
selecting at least one protected content engine based on the virtual device.

18. The computer-readable media of claim 15, wherein the method further comprises:
selecting at least one protected content engine based on a selection received from a user.

19. The computer-readable media of claim 16, wherein the method further comprises:
selecting at least one protected content engine based on local parameters.

20. The computer-readable media of claim 16, wherein the device profile is received from a secure portion of the storage medium.
